(19) United States
(12) Patent Application Publication
(10) Pub. No.: US 2013/0162009 A1
(43) Pub. Date: Jun. 27, 2013

(54) ELECTRIC VEHICLE REGENERATIVE BRAKING SYSTEM

(71) Applicants: Kurt Mitts, Santa Monica, CA (US); Ali Maleki, Canton, MI (US); Broc William TenHouten, Santa Monica, CA (US)

(72) Inventors: Kurt Mitts, Santa Monica, CA (US); Ali Maleki, Canton, MI (US); Broc William TenHouten, Santa Monica, CA (US)

(73) Assignee: Coda Automotive, Inc., Los Angeles, CA (US)

(21) Appl. No.: 13/335,436

(22) Filed: Dec. 22, 2011

(51) Int. Cl. B60T 13/58; B60T 8/1755; B60T 8/176; B60T 13/74

(52) U.S. Cl. 303/3; 701/70

(57) ABSTRACT

A method and system for braking a vehicle are disclosed. The vehicle has at least one of an electronic stability control system and an antilock brake system. The vehicle may also include a regenerative brake adapted to apply a regenerative braking torque to slow the vehicle. The vehicle may further include a pressure sensor adapted to sense pressure in a hydraulic brake line. The pressure sensor may be a component of the at least one of the electronic stability control system and the antilock brake system. The vehicle may also include a controller adapted to control the regenerative braking torque of the regenerative brake based on at least the sensed pressure.

### FIELD

Aspects relate generally to a regenerative braking system for use in electric vehicles (EVs) including all-electric vehicles, hybrid electric vehicles and plug-in hybrid electric vehicles.

### BACKGROUND

Regenerative braking systems employed in EVs may be used to recover kinetic energy that would otherwise be lost as heat and wear in traditional friction braking systems. In the regenerative braking system, the motor used to rotate the wheels is also used as a generator. When braking is desired, wheel rotation is converted into electrical power by the motor/generator and the vehicle slows. This power is then converted by the inverter into a form that is acceptable to recharge the vehicle battery. Thus, regenerative braking may return energy to the battery system boosting efficiency.

### SUMMARY

The inventors have recognized and appreciated the advantages of an integrated strategy for regenerative energy recovery in an EV as disclosed herein. The system may make use of information regarding driving conditions, such as brake pedal input, accelerator pedal input, vehicle speed input, temperature input, information from the driveline control module or motor control module, information from a human machine interface input, and/or information from the electronic stability control (ESC) system or antilock brake system (ABS), both of which may include an integrated pressure sensor. In one embodiment, pressure information from the existing pressure sensor in either the ABS or ESC system may be utilized by the regenerative braking controller.

In one exemplary embodiment, a braking system for a vehicle is provided. The vehicle has at least one of an electronic stability control system and an antilock brake system. The vehicle may also include a regenerative braking system adapted to apply a regenerative braking torque to slow the vehicle. The vehicle may further include a pressure sensor adapted to sense pressure in a hydraulic brake line. The pressure sensor may be a component of the at least one of the electronic stability control system and the antilock brake system. The vehicle may also include a controller adapted to control the regenerative braking torque of the regenerative braking system based at least in part on the sensed pressure.

In another exemplary embodiment, a method for braking a vehicle having at least one of an electronic stability control system and antilock brake system is provided. The method may include the steps of: receiving hydraulic pressure information from a pressure sensor of the at least one of the electronic stability control system and antilock brake system of the vehicle; and applying a regenerative braking torque to slow the vehicle in response to the hydraulic pressure information.

In yet another exemplary embodiment, a method for braking a vehicle is provided. The method may include the steps of disabling regenerative braking for an accelerator input above a threshold accelerator input; increasing regenerative braking for a decreasing accelerator input when the accelerator input is below the threshold accelerator input; increasing regenerative braking when a brake switch actuates; and increasing regenerative braking relative to increasing braking pressure.

It should be appreciated that all combinations of the foregoing concepts and additional concepts discussed in greater detail below, provided such concepts are not mutually inconsistent, are contemplated as being part of the inventive subject matter disclosed herein. In addition, all combinations of claimed subject matter are contemplated as being part of the inventive subject matter disclosed herein.

The foregoing and other aspects, embodiments, and features of the present teachings can be more fully understood from the following description in conjunction with the accompanying drawings.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. Various embodiments of the invention will now be described, by way of example, with reference to the accompanying drawings, in which:

FIG. 1 is a schematic representation of a braking system including the currently disclosed regenerative braking system controller;

FIG. 2 is a representative graph of regenerative braking torque versus accelerator pedal position;

FIG. 3 is a representative graph of regenerative braking torque versus braking pressure;

FIG. 4 is an exemplary flow diagram of the operation of the regenerative braking system during a braking event;

FIGS. 5A-5B are graphs that illustrate an example profile of the torque applied in a vehicle as a function of vehicle speed and accelerator pedal position in accordance with some embodiments;

FIGS. 6A-6B are graphs that illustrate another example profile of the torque applied in a vehicle as a function of vehicle speed and accelerator pedal position in accordance with some embodiments;

FIGS. 7A-7B are graphs that illustrate a further example profile of the torque applied in a vehicle as a function of vehicle speed and accelerator pedal position in accordance with some embodiments; and

FIGS. 8A-8B are graphs that illustrate an example profile of the torque applied in a vehicle as a function of vehicle speed and braking pressure in accordance with some embodiments.

### DETAILED DESCRIPTION

Aspects of the invention are described herein with reference to the figures, which show various illustrative embodiments. The embodiments disclosed herein are not necessarily intended to include all aspects of the invention. It should be appreciated, then, that the various concepts and embodiments introduced above and those discussed in greater detail below may be implemented in any of numerous ways, as the disclosed concepts and embodiments are not limited to any particular manner of implementation. In addition, it should be understood that some aspects of the invention may be used alone or in any suitable combination with other aspects of the invention.

The regenerative braking system of an EV may be used to recover kinetic energy while braking, thus returning energy to the battery system. The recapture of energy during braking may reduce the inefficiency otherwise introduced via traditional friction braking. In the regenerative braking system, when braking is desired the motor may be used as a generator, resisting travel in the direction of motion. The power generated by the motor when acting as a generator may then be converted by an inverter into a form that is acceptable to recharge the vehicle battery. The regenerative braking system is often used in cooperation with a friction braking system.

The current disclosure introduces an integrated strategy for regenerative energy recovery in an electric vehicle. The regenerative braking system may be controlled in response to any of a variety of inputs, including for example hydraulic pressure in the conventional friction braking system. Other inputs may include one or more inputs from the brake pedal, the brake switch, the accelerator pedal, the driveline control module or motor control module, and the electronic stability control (ESC) system or antilock brake system (ABS). Each of the ESC and ABS systems may include at least one pressure sensor to sense hydraulic pressure in the friction braking system. However, the sensed pressure is not output to other systems, and instead is used for control purposes within the ABS or ESC system itself. Thus, in addition to the above, the inventors have recognized the advantages of outputting the pressure signal from the pressure sensor of either the ABS or ESC system to a controller area network (CAN), or other appropriate vehicle network or connection, for access and use by the controller of the regenerative braking system. Information from the pressure sensors may be used to modify the amount of regenerative braking supplied during a braking event. For example, when there are no pedal inputs, some coast-down regenerative braking may be applied. As the brake pedal is depressed it may actuate a brake switch and additional regenerative braking may be applied in advance of substantial pressure being built in the brake lines and application of the friction braking system. As braking pressure continues to increase, additional regenerative braking may be ramped on to further assist in the braking of the vehicle.

The regenerative braking system may be controlled in response to other inputs, such as the vehicle speed input, accelerator input, temperature input and information input from a human machine interface (HMI). In some embodiments, a vehicle may be set to one of a variety of particular drive modes, each mode implementing a pattern of regenerative braking where the regenerative braking torque applied to the vehicle depends on various sensed parameters when in a that particular drive mode. Turning now to the figures, certain aspects of the braking system will be described in more detail.

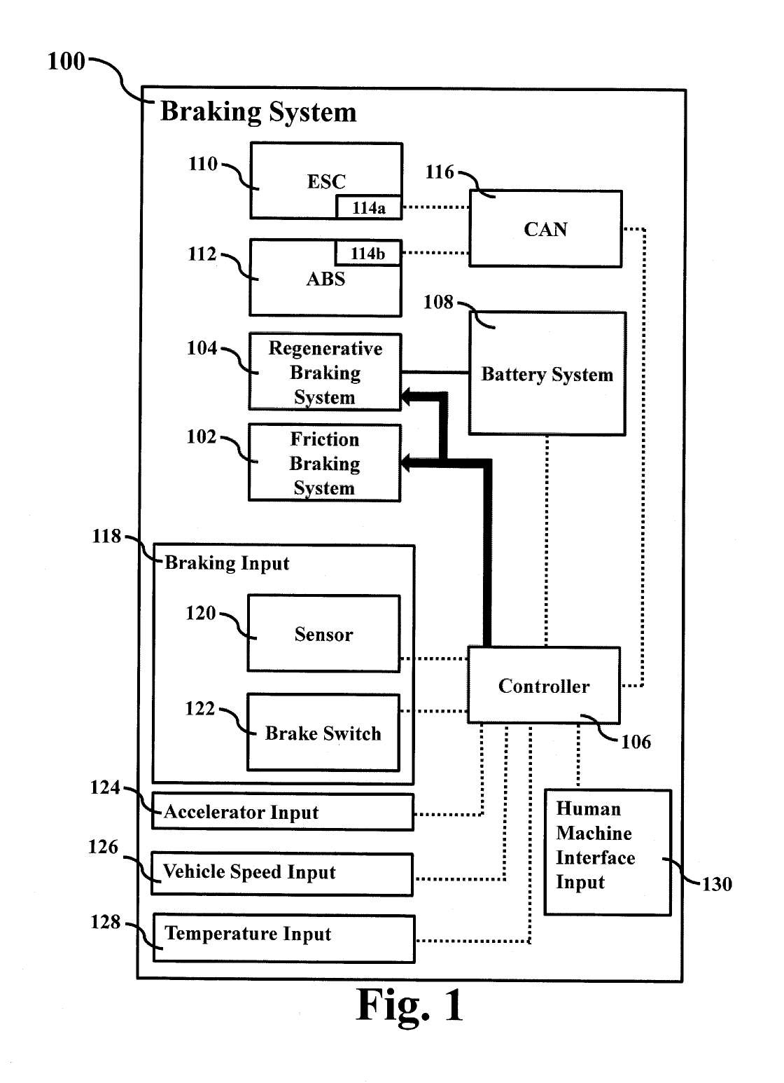

As shown in FIG. 1, a braking system 100 includes a friction braking system 102 and regenerative braking system 104. A controller 106 may be used in controlling communication with the friction and regenerative braking systems, indicated by the solid arrows. In some embodiments, the controller may only be in controlling communication with the regenerative braking system. During a regenerative braking event the regenerative braking system may charge a battery system 108, indicated by the solid line. The controller may command the regenerative braking system to initiate, remove, or modulate a preselected, or dynamically changing, regenerative torque to slow the vehicle. The applied regenerative torque may depend on multiple inputs supplied to the controller. Inputs to the controller are indicated by dashed lines in FIG. 1.

Either an ESC system 110 or ABS system 112 may output a pressure signal regarding the brake line hydraulic pressure from a pressure sensor 114a or 114b, respectively, to a controller area network (CAN) 116. The controller 106 may then receive the pressure signal from the CAN. The controller 106 may also receive braking inputs 118 from a brake sensor 120 and/or brake switch 122. The brake sensor may sense a displacement of the brake pedal, an angular position of the brake pedal, a rate of depression of the brake pedal, or other appropriate data. According to the sensed pressure signal input to the CAN, the controller may adjust the regenerative braking system to apply a suitable regenerative braking torque to slow the vehicle.

The controller 106 may also receive an accelerator input 124 related to the accelerator pedal position. The accelerator input may be related to a percentage of the total available accelerator pedal depression, an angular position of the pedal, a commanded motor torque, a percentage of available motor power, or other appropriate data. Depending on how much, or how little, the accelerator pedal is depressed, the controller may adjust the regenerative braking system to apply an appropriate regenerative braking torque. For example, the applied regenerative braking torque may decrease as the accelerator pedal is depressed past a certain position.

In addition to the above, the controller 106 may receive input from the battery system. The battery system may communicate a state of charge, error messages, a temperature, a current charge or discharge rate, and/or a maximum allowable charge rate of the battery system. In some embodiments, when it is determined that the battery system requires or should otherwise be charged, the controller may cause the regenerative braking system to apply a regenerative braking torque that results in the battery to be recharged.

The controller 106 may receive a signal from a vehicle speed input 126 which provides information related to how fast the vehicle is traveling. Information for the vehicle speed input may be derived from the indication provided by the vehicle speedometer or may be provided through an independent measurement, such as by tracking the rotational velocity of the wheels, by a direct measurement of the vehicle speed, or other appropriate data, e.g., GPS data. Based on how fast the vehicle is traveling, it may be determined that the application of a certain amount of regenerative braking torque may be appropriate. For example, a greater amount of regenerative braking torque may be applied when the vehicle is traveling faster as compared to when the vehicle is traveling slowly, or vice versa. In some embodiments, the amount of regenerative braking torque is greater within a certain regime of vehicle speed input (e.g., greater than 10 kph, between 10-80 kph, between 10-60 kph) as opposed to other regimes.

The controller may also receive a signal from a temperature input 128 which relates to the ambient temperature or temperature of certain parts of the vehicle. As will be described further below, it may be desirable for regenerative braking to be reduced when ambient temperatures are below freezing such that the possibility for skidding or wheel slippage may be decreased.

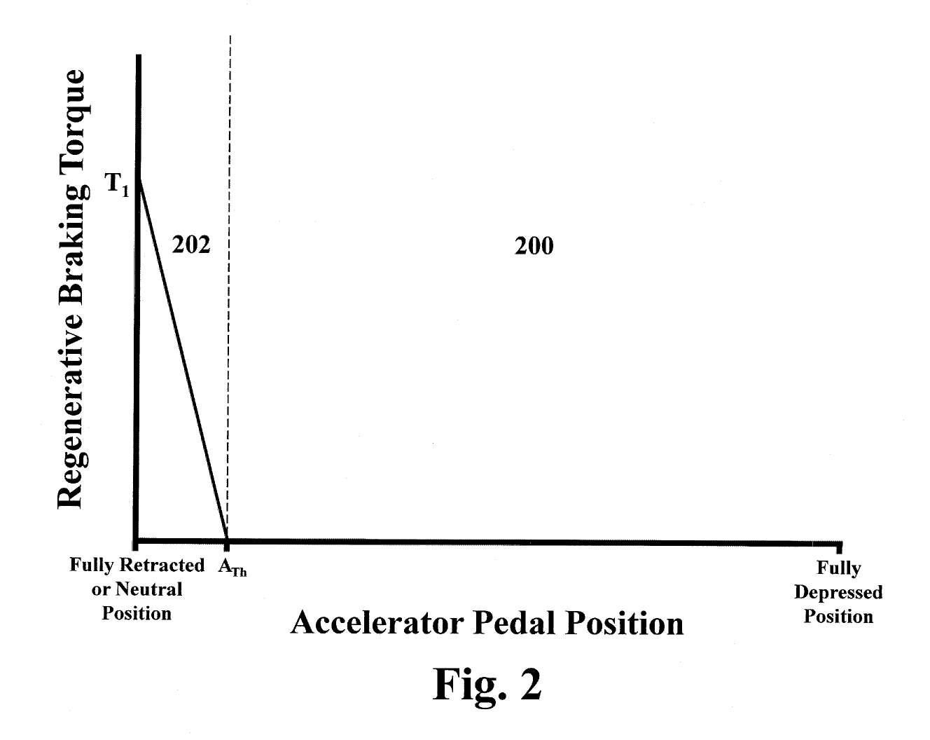

The controller may further receive signal from a human machine interface (HMI) input 130. The HMI input 130 may include a physical switch or virtual switch, such as a switch provided via the radio/telematics unit, which reports information to the controller via CAN or any other electrical interface. This switch allows the driver to suitably adjust regenerative torque profiles, for example, regenerative torque profiles shown in FIGS. 2-3 and 5A-8B. In some embodiments, the HMI allows for the vehicle to be placed in various drive modes (e.g., normal, economy, sport). Non-limiting examples of such drive modes will be described further below. In some embodiments, it may be desirable to define a set of operation modes in which the regenerative braking system may operate. The operation modes may be used to determine different aspects of vehicle control and operation. For instance the operation modes may correspond to vehicle acceleration, coasting, moderate braking, emergency braking, skidding, loss of control, and other appropriate vehicle control scenarios. The response of the regenerative braking system may be optimized for each of the defined modes of operation relative to either braking, energy regeneration, or both. In one embodiment, the system may accept five modes of user, or pedal related, input as detailed below.

To prevent unnecessary regenerative braking during acceleration, or maintaining a speed, of the vehicle, regenerative braking may be disabled. Thus, a first mode of operation may be defined when the accelerator input is above a threshold accelerator input corresponding to acceleration, or maintaining a speed, of a vehicle. The threshold accelerator input may be constant, or it may be variable to optimize performance of the regenerative braking system. The value of the threshold may depend on driver inputs, driving conditions, the projected driving route, and/or environmental conditions.

Similar to the use of engine braking in a standard vehicle with an internal combustion engine, it may be desirable to apply regenerative braking even when there is no brake pedal input. Therefore, regenerative braking may be used to simulate engine braking and afford an additional opportunity to recover energy and boost efficiency. Consequently, a second operation mode may be defined when the accelerator input is below the threshold accelerator input described above and no brake pedal inputs are provided. During this mode of operation an increasing regenerative braking torque may be applied relative to the decreasing accelerator input below the threshold accelerator input.

To further enable simulated engine braking by the regenerative braking system a third operation mode may be where there is no input from both of the accelerator and brake pedals. In other words, the vehicle is coasting. When the vehicle is coasting, the regenerative braking system may provide a similar, or increased, amount of regenerative braking as provided when the accelerator pedal position reached its neutral fully extended position. Vehicle coasting may be inferred by the absence of accelerator input, the absence of brake light switch actuation, and/or by the absence of significant hydraulic pressure in the friction braking system.

To provide additional energy regeneration, it may be desirable to increase the regenerative braking torque substantially prior to the application of the friction braking system. As the brake pedal is depressed during a braking event, the hydraulic braking pressure increases and the brake switch actuates. In some instances, actuation of the brake switch may occur at a brake pedal depression prior to application of any significant friction braking. Therefore, in one embodiment, a fourth operation mode may be defined by actuation of the brake switch. In this mode of operation, the regenerative braking system may apply an increased regenerative braking torque prior to application of the friction braking system, thus increasing vehicle efficiency. The use of the brake switch may also provide additional safety, allowing for regenerative braking to be activated, or increased, even when there is no fluid and/or pressure in the brake lines.

In some embodiments, the amount of regenerative braking may increase with further increasing brake pedal depression and/or hydraulic braking pressure corresponding to increased braking demand. Thus, a fifth operation mode may be when the brake pedal depression/hydraulic braking pressure is greater than a threshold brake pedal depression/hydraulic braking pressure. During this mode of operation, the regenerative braking torque may increase proportionally to increasing brake pedal depression and/or hydraulic braking pressure. In some instances, the threshold may correspond to the brake pedal depression, or corresponding hydraulic braking pressure, during brake switch actuation. Alternatively, the threshold may be at a point prior to or after the brake switch actuation. Furthermore, the threshold may be a preset point, or it may be a dynamic variable based on driver inputs, driving conditions, the projected driving route, and/or environmental conditions.

FIG. 2 presents an exemplary applied regenerative braking torque function versus the accelerator pedal position. The accelerator pedal position is depicted as varying between a fully retracted or neutral accelerator pedal position (i.e. no accelerator input) and a fully depressed accelerator pedal position (i.e. maximum accelerator input). The depicted regenerative braking function includes a region 200 corresponding to a positive engine power output and a region 202 corresponding to simulated engine braking. In region 200, the accelerator pedal position is greater than a preselected threshold accelerator pedal position A_{Th} and no regenerative braking torque is applied. Region 202 corresponds to an accelerator pedal position below the preselected threshold A_{Th}. In region 202, the amount of regenerative braking torque may increase to a torque T₁ as the accelerator pedal position approaches full retraction. In some instances the amount of regenerative braking torque may be linear, as depicted, or alternatively, non-linearly. Additionally, the function by which the regenerative braking torque changes may be a set function, or it may be variable dependent on driver inputs, driving conditions, the projected driving route, and/or environmental conditions.

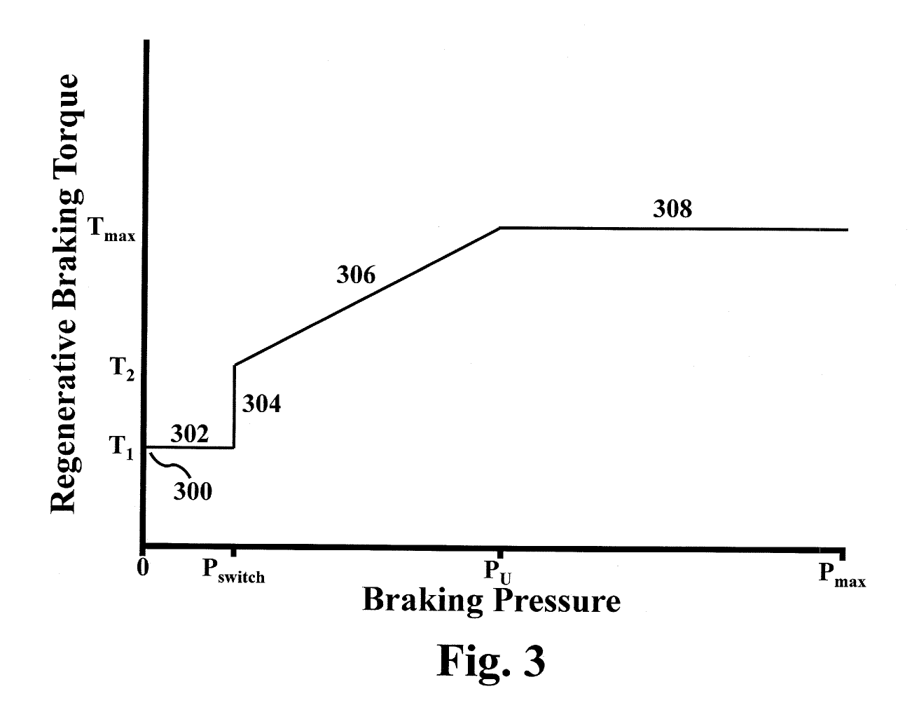

FIG. 3 depicts an exemplary regenerative braking function versus braking pressure as measured by the pressure sensor in the ABS or ESC system. The applied braking pressure varies between zero and a maximum applied braking pressure Pₘₐₓ. The Regenerative braking torque is defined between zero and a maximum regenerative torque Tₘₐₓ.

Point 300 in FIG. 3 corresponds to no accelerator or braking pedal inputs, i.e. coasting. Consistent with the above description of coasting disclosed with respect to no accelerator input, a regenerative braking torque T₁ may be applied during coasting to slow the vehicle and provide additional energy recovery.

To increase the amount of recovered energy during a braking event, it may be beneficial to increase the regenerative braking torque prior to application of any significant braking imparted by the friction braking system. In segment 302, the brake pedal is being depressed, and pressure is building in the brake lines. However, insufficient pressure develops in segment 302 to substantially apply the friction braking system. The regenerative braking torque may be held constant during the initial increase in braking pressure until the brake switch actuates in response to the brake pedal depression at a corresponding braking pressure P_{switch}. In some embodiments the regenerative braking torque may then increase to a regenerative braking torque T₂ in segment 304 upon actuation of the braking switch. The brake switch actuation, and corresponding increase in regenerative braking torque, may both occur prior to application of any significant braking by the friction braking system, which may increase the efficiency of the vehicle. Consequently, the pressure P_{switch} corresponding to when the brake switch is actuated by the brake pedal depression may be sufficiently small to avoid application of the friction braking system prior to increasing the regenerative braking torque. The above noted increase in torque may either be a step wise change in torque, or the controller may command a delay, or ramp, in the torque increase to provide a smooth transition between the applied braking torques.

As braking demand increases, as indicated by an increase in applied braking pressure, both the friction and regenerative braking systems may provide increased braking torque. In one embodiment, the applied regenerative braking torque may increase with increasing sensed braking pressure as shown in segment 306. While a linear relationship with braking pressure has been depicted, it should be understood that the regenerative braking torque may follow other functions including, but not limited to, geometric, exponential, non-linear, a predefined, or variable function. Furthermore, the function may depend on driver inputs, driving conditions, the projected driving route, and/or environmental conditions.

In some instances, it may be necessary to limit the maximum regenerative braking torque. This may be necessary either due to limitations of the motor, transmission, battery, electrical system, and/or other appropriate design constraints. As depicted in FIG. 3, the regenerative braking torque may increase to a maximum regenerative braking torque, Tₘₐₓ, at an upper threshold pressure, P_{U}. As indicted by braking segment 308, the regenerative braking torque may remain constant for sensed braking pressures above P_{U} through the maximum braking pressure Pₘₐₓ.

Each of the above noted set points T₁, T₂, Tₘₐₓ, P_{switch}, P_{U}, and Pₘₐₓ may be constant or variable dependent on driver inputs, driving conditions, the projected driving route, and/or environmental conditions. While a particular regenerative braking function versus sensed braking pressure has been described in relation to FIG. 3, it should be understood that any number of braking behaviors could be implemented versus sensed braking pressure without departing from the spirit of this disclosure.

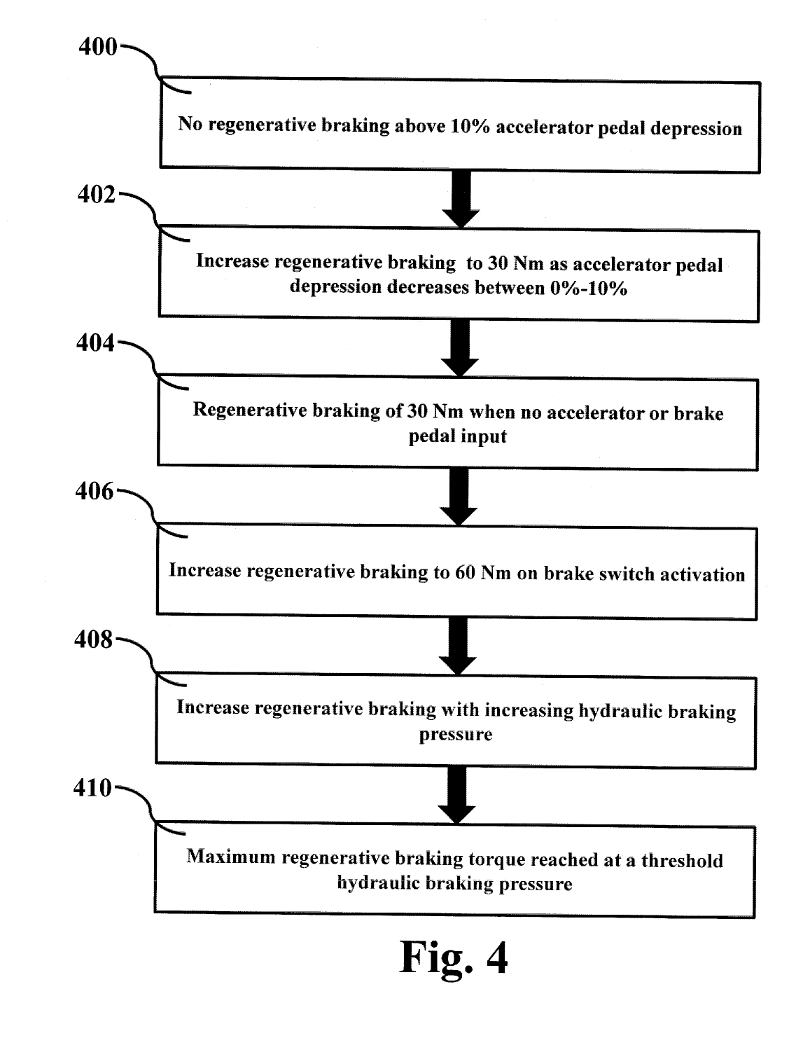

An exemplary embodiment of a method implementing the braking strategy described above in relation to FIG. 3 is presented in FIG. 4. The disclosed method presents specific thresholds and regenerative braking system functionality versus accelerator and brake pedal inputs.

To ensure forward power without unnecessary activation of the regenerative braking system, an accelerator pedal depression threshold may be defined, above which the regenerative braking system may be disabled. In one embodiment, at, and above, 10% accelerator pedal depression, no regenerative braking may be implemented, see step 400. In other embodiments, the threshold may correspond to 20%, 30%, or any other appropriate percentage of accelerator pedal depression.

As discussed above, simulated engine braking using the regenerative braking system may also be desirable as an additional opportunity to recovery energy. Therefore, in step 402, between 0% and 10% of accelerator pedal depression, forward power may be absent, and regenerative braking may be ramped up linearly from 0 to 30 Nm as the accelerator pedal reaches its fully retracted position. Alternatively, the regenerative braking torque may be ramped to 60 Nm, 90 Nm, or any other appropriate value. In another embodiment, the regenerative braking torque may begin to increase at 20%, 30%, or any other appropriate value.

To provide smooth braking operation, the regenerative braking torque applied to simulated engine braking may continue during coasting with no accelerator or braking pedal input. During coasting, the regenerative braking system may command, or maintain, the regenerative braking torque corresponding to the simulated engine braking, as shown in step 404. In other instances, the regenerative torque may increase after release of the accelerator pedal. The additional increase in regenerative braking torque may be immediate, or it may increase over a predetermined time duration.

Prior to substantial braking by the friction braking system, as described above it may be desired to increase the amount of regenerative braking to recover additional energy and boost vehicle efficiency. In step 406, the brake switch may be activated prior to substantial application of the friction braking system, and an additional 30 Nm may be added bringing the total regenerative torque of the regenerative braking system to 60 Nm. In other instances, the regenerative braking torque may increase by 60 Nm, 90 Nm, or any other appropriate value.

As braking demand increases further, it may be desirable to increase the amount of regenerative braking in proportion to the amount of friction braking. In one embodiment, as the brake pedal is depressed further, pressure may build in the hydraulic brake lines of the friction brakes, and regenerative braking may increase relative to a corresponding increase in the brake line pressure, as indicated in step 408. As mentioned above, in some instances, regenerative braking may increase according to a linear, geometric, exponential, non-linear, a predefined, or variable function. The function may be dependent on driver inputs, driving conditions, the projected driving route, and/or environmental conditions.

As noted in more detail above, due to system limitations, the maximum amount of regenerative braking may be limited. In step 410, the regenerative braking system provides a maximum regenerative torque when a threshold hydraulic pressure (e.g., pressure of 25 bar), or greater, is sensed in the brake lines. It can be appreciated that pressure and torque values may vary appropriately depending on the powertrain and size of the vehicle.

While specific accelerator pedal position percentages, regenerative torques, and braking pressures have been noted above, one of skill in the art would recognize that the above values are arbitrary and that any number of braking functions may be implemented to provide a desired regenerative braking performance.

Without wishing to be bound by theory, the amount of regenerative braking available at any given moment during vehicle operation may be related to the speed of the vehicle. As the vehicle's speed decreases, the available regenerative braking torque may also decrease. Thus, at slower speeds a greater portion of the vehicle braking may be provided by the friction braking system. In view of the above, the regenerative braking system function, and the overall interaction between the vehicle braking systems, may change depending upon the speed of the vehicle. The way in which the braking function changes may be governed by a speed control strategy, or torque modified speed control strategy. This may occur at speeds below a particular threshold, such as 5 miles per hour, 10 miles per hour, 15 miles per hour, or another appropriate speed. In some embodiments, regenerative braking is applied until the vehicle is slowed down to a desired vehicle creep speed, and then the regenerative braking is reduced to zero. Vehicle creep may refer to situations where neither the acceleration pedal nor the brake pedal is depressed, yet the vehicle continues to move forward. Vehicles described in accordance with the present disclosure may or may not be configured to exhibit vehicle creep. Additionally, in some embodiments, it may be desirable to input pedal depression rates into controller 106 to alter braking and acceleration strategies. For example, the amount of applied regenerative braking torque may increase with increasing brake pedal depression rate which may indicate an emergency braking situation.

In some instances, implementation of the above detailed overall braking strategy may lead to a loss of control, or wheel slippage, as might occur during driving on ice or another slick surface. Therefore, it may be desirable to reduce the coast down regenerative braking for traction in the event that wheel slippage is detected. Furthermore, the braking system may disable, or reduce, regenerative braking if either the ABS or ESC system is activated during coasting, and/or simulated engine braking. Similar actions may also be taken to disable, or reduce, regenerative braking during normal brake application when the ABS or ESC system is activated.

Ambient temperature measurement may be used to modify the braking strategy as well. Temperatures at various locations of the vehicle, such as internal to the motor, at the inverter and battery cells, or ambient temperature around the vehicle may provide guidance (e.g., limits) as to the amount of regeneration that is safely permitted by the system and, for example, may cause an offset to the regenerative braking profiles shown in FIGS. 2 and 3. For example, at temperatures below freezing, there is a greater probability that road conditions will be icy. To improve drivability of the vehicle, during treacherous conditions and to avoid the possibility of skidding or wheel slippage, the overall amount of regenerative braking may be reduced, such as when the braking pedal is not depressed, or when the braking pedal is at least partially depressed. Temperature inputs may also be used to adjust the blending of regenerative braking and frictional braking, to avoid skid and wheel slip.

Selectable drive modes may be implemented which effect the regenerative braking strategy. For instance, the vehicle may be placed in a normal drive mode, an economy drive mode or a sport drive mode. The vehicle may be placed in an economy drive mode when it is desirable for a relatively larger amount of energy to be regenerated. On the other hand, the vehicle may be placed in a sport drive mode when it is generally less desirable for regenerative braking to occur and either a minimum amount or no amount of regenerative braking occurs when the accelerator pedal is not depressed. The vehicle may be placed in a normal drive mode which is an intermediate drive mode between the economy and sport drive modes. When set to a normal drive mode, the vehicle would exhibit an intermediate level of off-pedal regenerative braking as compared to the amount of off-pedal regenerative braking in the economy and sport drive modes. Other drive modes are possible, arising in a suitable regenerative braking profile depending on any of the inputs described herein.

In some embodiments, regenerative braking in a vehicle set to an economy drive mode is applied when the acceleration pedal is not depressed, however, regenerative braking in a vehicle set to the normal drive mode begins only when the acceleration pedal is slightly depressed. Though, when the vehicle is set to a sport drive mode, little to no regenerative braking in the vehicle occurs. In some embodiments, a vehicle set to a drive mode that is configured to apply a less amount of regenerative braking may provide better feel and handle for the driver, particularly in poor weather conditions (e.g., ice, rain, etc.).

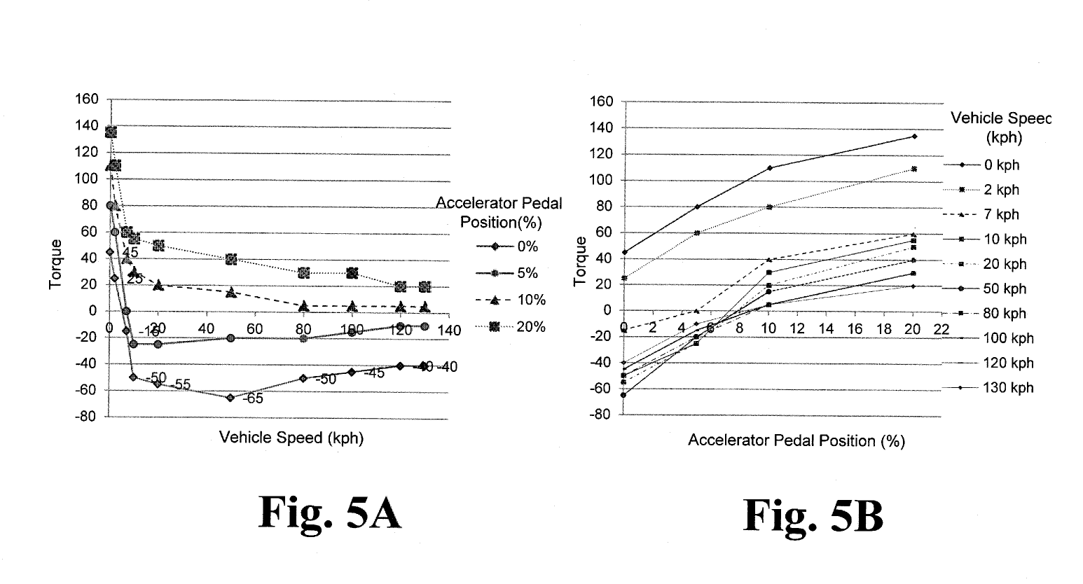

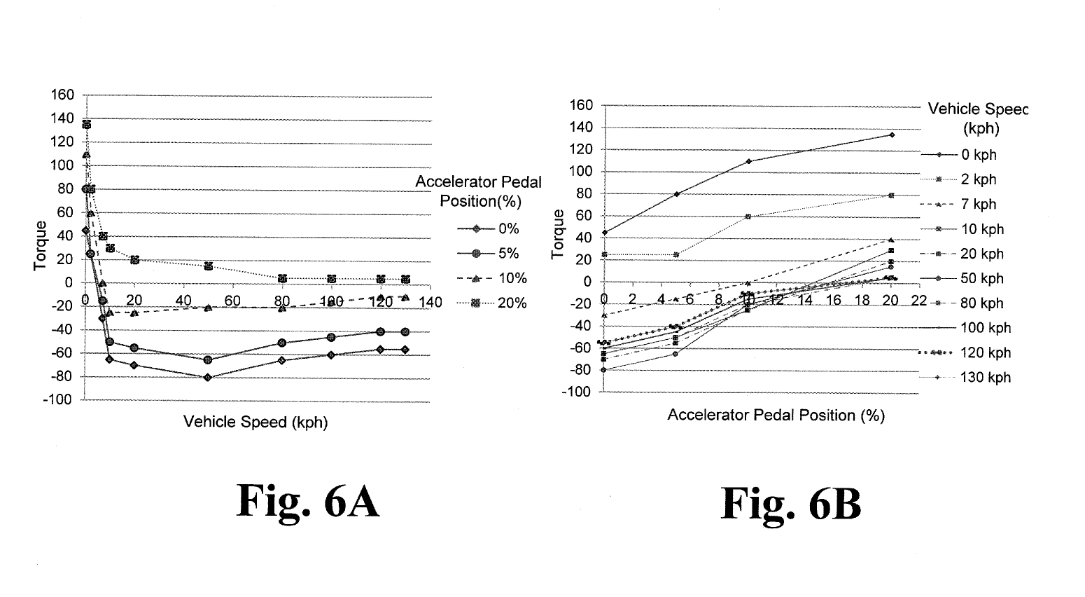

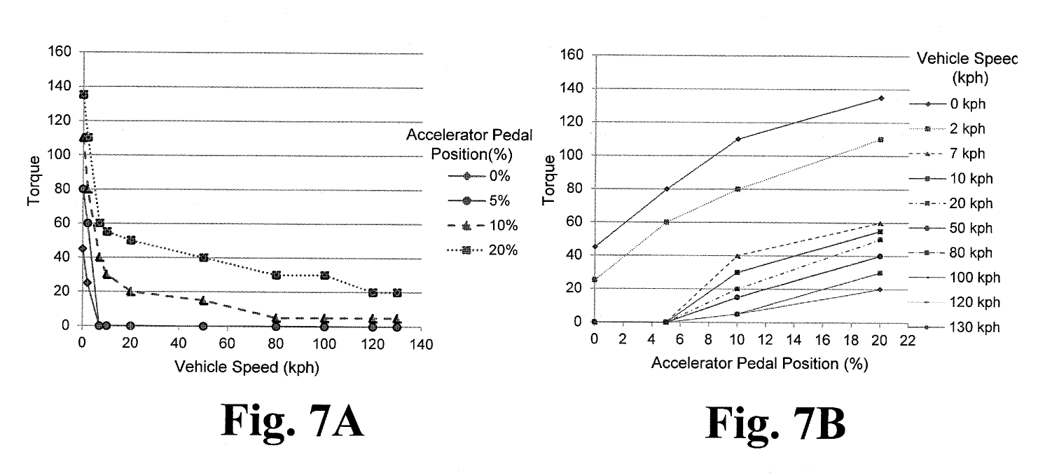

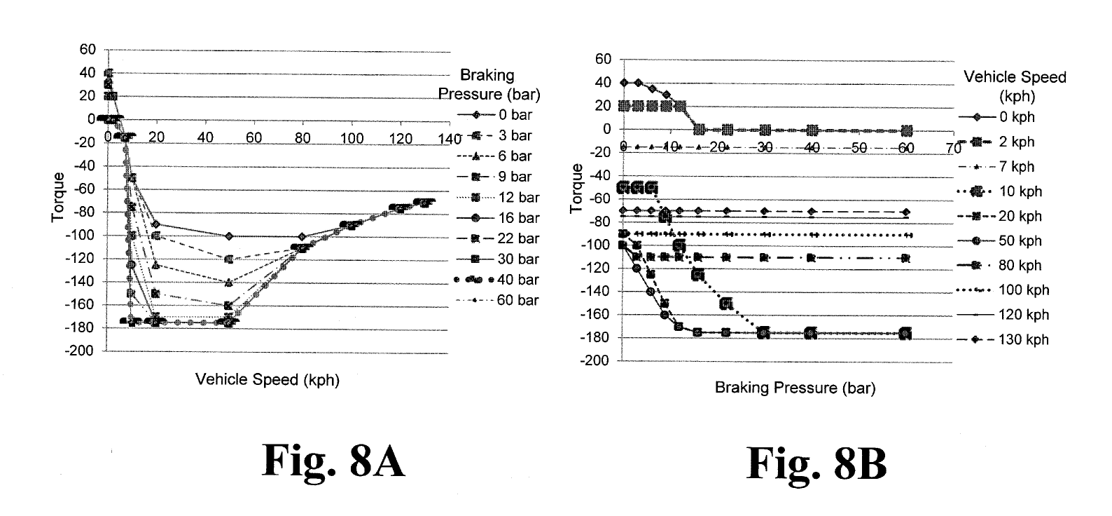

Tables 1-3 and FIGS. 5A-7B show the total amount of torque applied in an exemplary embodiment of a vehicle set in different drive modes (normal, economy, sport). The total torque applied is recorded as a function of the vehicle speed and the accelerator pedal position. Differences in the total amount of torque applied will vary in the vehicle depending on the levels of regenerative braking applied to the vehicle, hence, the drive mode the vehicle is set to. Table 4 and FIGS. 8A-8B show the total amount of torque applied in an exemplary embodiment of a vehicle as a function of the vehicle speed and the recorded braking pressure. FIGS. 5A-5B, FIGS. 6A-6B , FIGS. 7A-7B and FIGS. 8A-8B graphically depict the information listed in Tables 1-4, respectively. The torque recorded in Tables 1-4 and FIGS. 5A-8B is a total torque applied which accounts for torque arising from regenerative braking as well as torque arising from accelerative input. While frictional braking torque may also vary appropriately depending on the drive mode to which the vehicle is set, for purposes of these examples, the frictional braking torque profile is considered to be the same for vehicles set to the different drive modes. In addition, as shown, a negative total torque value indicates a braking torque that is applied, i.e., the vehicle is slowing down. A positive total torque value, on the other hand, indicates that an acceleration torque is applied where the vehicle increases in speed. It can be appreciated that the torque profiles exhibited in these examples provided (and represented in Newton-Meters) are merely illustrative and non-limiting, as other suitable torque profiles are within the spirit and scope of the present disclosure.

Table 1 and FIGS. 5A-5B provide information regarding the torque applied in an exemplary vehicle that is placed in a normal drive mode. When the vehicle is traveling at low speed (e.g., less than 10 kph), the amount of regenerative braking torque applied is in general proportion to the increase in speed. As shown in FIG. 5A, when the vehicle speed increases past the threshold speed of about 10 kph, the amount of regenerative braking torque applied plateaus to a generally constant level. When the accelerator pedal is not depressed or only slightly depressed (e.g., less than 10% of the fully depressed position), the amount of regenerative braking torque applied is greater than the positive acceleration torque that would arise if the accelerator pedal was more heavily depressed (e.g., more than 10% of the fully depressed position). As shown in FIG. 5B, the total torque applied steadily increases as accelerator pedal depression increases. For low vehicle speeds (e.g., speeds less than 5 kph), even when the accelerator pedal is not depressed, a slight amount of vehicle creep exists. When the vehicle is traveling at relatively high speeds and the accelerator pedal is not depressed, the regenerative braking torque is automatically applied.

TABLE 1
Torque dependency on acceleration pedal position (%) and vehicle
speed (kph) for a vehicle set to a Normal Drive Mode

Accelerator Pedal Position (%)

| | Normal | 0 | 5 | 10 | 20 |
|---|---|---|---|---|---|
| Vehicle | 0 | 45 | 80 | 110 | 135 |
| Speed | 2 | 25 | 60 | 80 | 110 |
| (kph) | 7 | −15 | 0 | 40 | 60 |
| | 10 | −50 | −25 | 30 | 55 |
| | 20 | −55 | −25 | 20 | 50 |
| | 50 | −65 | −20 | 15 | 40 |
| | 80 | −50 | −20 | 5 | 30 |
| | 100 | −45 | −15 | 5 | 30 |
| | 120 | −40 | −10 | 5 | 20 |
| | 130 | −40 | −10 | 5 | 20 |

Table 2 and FIGS. 6A-6B provide information regarding the torque applied in an exemplary vehicle that is placed in an economy drive mode. In the economy drive mode, the levels of regenerative braking in the vehicle are set such that a greater amount of regeneration energy can be harnessed by the kinetic energy provided from the vehicle (e.g., rotation of the wheels/shaft) as compared to when the vehicle is in the normal drive mode.

For instance, the total torque illustrated in FIGS. 6A-6B of the vehicle placed in an economy drive mode is substantially more negative than the total torque shown in FIGS. 5A-5B under the same conditions of the vehicle placed in the normal drive mode. Accordingly, when the vehicle is set to the economy drive mode, a substantial amount of regeneration occurs when no pedals, braking or acceleration, are depressed. At some speeds, regenerative braking may even be applied while the driver has his/her foot still partially on the accelerator pedal. The economy drive mode may be preferable for environmental enthusiasts and for city driving where the energy efficiency of the vehicle would generally be less. However, in some embodiments and as shown in this example, for low vehicle speeds (e.g., speeds less than 5 kph), despite the increased levels of regenerative braking torque applied in an economy drive mode, a slight amount of vehicle creep may still exist. Though, similar to that described above for the normal drive mode, when the vehicle travels faster and the accelerator pedal is not depressed or only partially depressed, the regenerative braking torque is automatically applied; yet, for the economy drive mode, the regenerative braking torque is greater than the regenerative braking torque that would be applied in the normal drive mode under the same conditions.

TABLE 2
Torque dependency on acceleration pedal position (%) and vehicle
speed (kph) for a vehicle set to an Economy Drive Mode

Accelerator Pedal Position (%)

| | Economy | 0 | 5 | 10 | 20 |
|---|---|---|---|---|---|
| Vehicle | 0 | 45 | 80 | 110 | 135 |
| Speed | 2 | 25 | 25 | 60 | 80 |
| (kph) | 7 | −30 | −15 | 0 | 40 |
| | 10 | −65 | −50 | −25 | 30 |
| | 20 | −70 | −55 | −25 | 20 |
| | 50 | −80 | −65 | −20 | 15 |
| | 80 | −65 | −50 | −20 | 5 |
| | 100 | −60 | −45 | −15 | 5 |
| | 120 | −55 | −40 | −10 | 5 |
| | 130 | −55 | −40 | −10 | 5 |

Alternatively, the vehicle may be placed in a sport drive mode where it is not important to the driver for regenerative braking to occur. Accordingly, the amount of regenerative braking is substantially reduced such that the vehicle is able to travel comparatively faster and, in some cases, provide more feel to the driver than if a greater amount of regenerative braking were to be implemented. As a result, in the sport drive mode, the driver may gain more control over the vehicle (e.g., in coasting around turns, etc.) than if the vehicle were placed in the economy drive mode.

Table 3 and FIGS. 7A-7B provide information regarding the torque applied in an exemplary vehicle that is placed in a sport drive mode. As shown, despite the vehicle speed or the level of depression of the accelerator pedal, the total torque applied to the vehicle is zero or greater than zero, i.e., the vehicle coasts or accelerates absent implementation of another braking mechanism (e.g., frictional brakes). Similar to that described above, when the vehicle is traveling at low speed and the accelerator pedal is not depressed, the vehicle may experience positive acceleration torque due to vehicle creep. However, when the vehicle travels faster and the accelerator pedal is not depressed, rather than regenerative braking torque being applied, the vehicle experiences little to no regenerative braking torque.

TABLE 3
Torque dependency on acceleration pedal position (%) and vehicle
speed (kph) for a vehicle set to a Sport Drive Mode

Accelerator Pedal Position (%)

| | Sport | 0 | 5 | 10 | 20 |
|---|---|---|---|---|---|
| Vehicle | 0 | 45 | 80 | 110 | 135 |
| Speed | 2 | 25 | 60 | 80 | 110 |
| (kph) | 7 | 0 | 0 | 40 | 60 |
| | 10 | 0 | 0 | 30 | 55 |
| | 20 | 0 | 0 | 20 | 50 |
| | 50 | 0 | 0 | 15 | 40 |
| | 80 | 0 | 0 | 5 | 30 |
| | 100 | 0 | 0 | 5 | 30 |
| | 120 | 0 | 0 | 5 | 20 |
| | 130 | 0 | 0 | 5 | 20 |

Table 4 and FIGS. 8A-8B provide information regarding the torque applied in an exemplary vehicle as a function of vehicle speed and braking pressure. As illustrated, where no braking pressure is recorded, when traveling at a low speed, the vehicle experiences a positive acceleration torque due to vehicle creep. However, when the vehicle travels at a greater speed, the regenerative braking torque is automatically applied, even when no braking pressure is sensed. As the brake pedal is depressed more and more, the braking pressure increases which generally gives rise to an increase in regenerative braking torque. Accordingly, as shown in FIG. 8B, braking pressures greater than a threshold amount (e.g., greater than 16 bar) give rise to a total torque applied to the vehicle of zero or less, causing the vehicle to decelerate. As the braking pressure increases, the regenerative braking torque also increases. Yet, as the vehicle speed increases past a certain threshold (e.g., greater than 50 kph), despite an increase in the sensed braking pressure, the regenerative braking torque still decreases. While not a required aspect for embodiments of the present disclosure, the amount of regenerative braking torque may decrease when the vehicle speed is above a certain threshold (e.g., greater than 50 kph) so as to allow for the driver to maintain stability and control of the vehicle.

TABLE 4
Torque dependency on braking pressure (bar) and vehicle speed (kph).

| | | Braking Pressure (bar) | | | | | | | | | |
|---|---|---|---|---|---|---|---|---|---|---|---|
| | | 0 | 3 | 6 | 9 | 12 | 16 | 22 | 30 | 40 | 60 |
| Vehicle | 0 | 40 | 40 | 35 | 30 | 20 | 0 | 0 | 0 | 0 | 0 |
| Speed | 2 | 20 | 20 | 20 | 20 | 20 | 0 | 0 | 0 | 0 | 0 |
| (kph) | 7 | −15 | −15 | −15 | −15 | −15 | −15 | −15 | −15 | −15 | −15 |
| | 10 | −50 | −50 | −50 | −75 | −100 | −125 | −150 | −175 | −175 | −175 |
| | 20 | −90 | −100 | −125 | −150 | −170 | −175 | −175 | −175 | −175 | −175 |
| | 50 | −100 | −120 | −140 | −160 | −170 | −175 | −175 | −175 | −175 | −175 |
| | 80 | −100 | −110 | −110 | −110 | −110 | −110 | −110 | −110 | −110 | −110 |
| | 100 | −90 | −90 | −90 | −90 | −90 | −90 | −90 | −90 | −90 | −90 |
| | 120 | −75 | −75 | −75 | −75 | −75 | −75 | −75 | −75 | −75 | −75 |
| | 130 | −70 | −70 | −70 | −70 | −70 | −70 | −70 | −70 | −70 | −70 |

The above disclosed braking strategies generally apply to singular driver inputs, i.e. the accelerator and brake pedals are not depressed at the same time. However, in some instances, a driver may depress both pedals and it may be necessary to either cancel an input or define how the separate inputs may be used in combination to define an overall braking system response. In one embodiment, the accelerator input may be canceled when the brake pedal is depressed. Alternatively, in a hill hold situation, where it may be necessary to maintain the brakes until a forward thrust is generated, a strategy may be implemented allowing multiple driver inputs, such as both the brake and accelerator pedal inputs. The resultant drive torque may then be defined as a complex function of the accelerator and brake pedal position and/or hydraulic line pressure. Alternatively, the regenerative braking system may be disabled when multiple inputs are sensed and the motor may simply act as a drive motor and the friction braking system may provide the necessary braking for the vehicle.

In some embodiments, it may be desired to provide brake system monitoring, notification of possible maintenance issues, and/or apply additional braking. In one embodiment, the regenerative braking system may use brake pedal position sensor information to provide additional information regarding pedal feel, or displacement, versus brake line pressure. For example, if the brake pedal exhibits excessive travel due to low line pressure, additional regenerative braking may be applied to increase the available braking torque and thus slow the vehicle. If the braking parameters are significantly far from expected values, a trouble code may be set along with a lamp on the dash to indicate a brake system problem requiring maintenance.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A braking system for a vehicle, the vehicle having at least one of an electronic stability control system and an antilock brake system, the braking system comprising:
a regenerative braking system adapted to apply a regenerative braking torque to the vehicle to slow the vehicle;
a pressure sensor adapted to sense pressure in a hydraulic brake line, wherein the pressure sensor is a component of the at least one of the electronic stability control system and the antilock brake system; and
a controller adapted to control the regenerative braking torque of the regenerative braking system based at least in part on the sensed pressure.

2. The braking system of claim 1, wherein the controller is adapted to increase the regenerative braking torque in response to an increase in the sensed pressure.

3. The braking system of claim 2, wherein the controller is adapted to increase the regenerative braking torque linearly in response to the increase in the sensed pressure.

4. The braking system of claim 1, wherein the regenerative braking torque is a maximum regenerative braking torque when the sensed pressure is greater than an upper threshold pressure.

5. The braking system of claim 1, wherein the controller is adapted to disable the regenerative braking for an accelerator input greater than a threshold accelerator input.

6. The braking system of claim 1, wherein the controller is adapted to increase the regenerative braking torque as an accelerator input decreases from a threshold accelerator input.

7. The braking system of claim 1, wherein the controller is adapted to maintain the regenerative braking torque at a constant positive torque when no accelerator or braking inputs are sensed.

8. The braking system of claim 1, wherein the controller is adapted to increase the regenerative braking torque when the vehicle travels above a threshold vehicle speed input.

9. The braking system of claim 1, wherein the controller is adapted to increase the regenerative braking torque in response to an actuation of a brake switch.

10. The braking system of claim 1, wherein the controller is adapted to increase the regenerative braking torque in response to increasing rates of pressure increase.

11. The braking system of claim 1, wherein the controller is adapted to decrease the regenerative braking torque in response to wheel slippage.

12. The braking system of claim 1, wherein the controller is adapted to provide a trouble code in response to sensed excessive brake pedal travel.

13. The braking system of claim 1, wherein the controller is adapted to adjust a profile of the regenerative braking torque in response to a change in vehicle speed input to the controller.

14. The braking system of claim 1 further comprising a drive mode selector that permits the controller to adjust a profile of the regenerative braking torque in response to an input provided by the drive mode selector.

15. A method for braking a vehicle having at least one of an electronic stability control system and antilock brake system, the method comprising:
receiving hydraulic pressure information from a pressure sensor of the at least one of the electronic stability control system and antilock brake system of the vehicle; and
applying a regenerative braking torque to slow the vehicle in response to the hydraulic pressure information.

16. The method of claim 16 further comprising increasing the regenerative braking torque in response to increasing hydraulic pressure.

17. The method of claim 17, wherein increasing the regenerative braking torque further comprises linearly increasing the regenerative braking torque with increasing hydraulic pressure.

18. The method of claim 16 further comprising applying a maximum regenerative braking torque when the hydraulic pressure is greater than an upper threshold pressure.

19. The method of claim 19, wherein the upper threshold pressure is approximately 25 bar.

20. The braking system of claim 16 further comprising disabling the regenerative braking for an accelerator input greater than a threshold accelerator input.

21. The braking system of claim 16 further comprising increasing the regenerative braking torque as an accelerator input decreases from a threshold accelerator input.

22. The braking system of claim 16 further comprising maintaining the regenerative braking torque at a constant positive torque when no accelerator or braking inputs are sensed.

23. The braking system of claim 16 further comprising increasing the regenerative braking torque in response to an actuation of a brake switch.

24. The method of claim 16 further comprising increasing the regenerative braking torque in response to increasing rates of hydraulic pressure rise.

25. The braking system of claim 16 further comprising decreasing the regenerative braking torque in response to wheel slippage.

26. The braking system of claim 16 further comprising providing a trouble code in response to excessive brake pedal travel.

27. The method of claim 16 further comprising sensing a speed of the vehicle and adjusting the regenerative braking torque in response to the speed of the vehicle.

28. The method of claim 16 further comprising sensing an ambient temperature and adjusting the regenerative braking torque in response to the ambient temperature.

29. The method of claim 16 further comprising selecting a driving mode and adjusting a profile of the regenerative braking torque in response to the selected drive mode.

30. A method for braking a vehicle comprising:
disabling regenerative braking for an accelerator input above a threshold accelerator input;
increasing regenerative braking for a decreasing accelerator input when the accelerator input is below the threshold accelerator input;
increasing regenerative braking when a brake switch actuates; and
increasing regenerative braking relative to increasing braking pressure.

31. The method of claim 31 further comprising maintaining a constant amount of regenerative braking for a braking pressure above a threshold braking pressure.

32. The method of claim 31 wherein the step of increasing regenerative braking relative to a decreasing accelerator input further comprises linearly increasing regenerative braking.
